(19) United States
(12) Patent Application Publication
(10) Pub. No.: US 2011/0050890 A1
(43) Pub. Date: Mar. 3, 2011

(54) METHOD AND SYSTEM FOR MEASURING STRUCTURAL VIBRATION USING CURVE FITTING FROM VIDEO SIGNAL

(75) Inventors: Young-Chul Choi, Daejeon (KR); Jin-Ho Park, Daejeon (KR); Hyeong Seop Jeon, Daejeon (KR); Doo-Byung Yoon, Daejeon (KR); Sung Hwan Shin, Daejeon (KR)

(73) Assignees: KOREA ATOMIC ENERGY RESEARCH INSTITUTE, Daejeon (KR); KOREA HYDRO & NUCLEAR POWER CO., LTD., Seoul (KR)

(21) Appl. No.: 12/871,641

(22) Filed: Aug. 30, 2010

(30) Foreign Application Priority Data
Sep. 2, 2009 (KR) 10-2009-0082554

(51) Int. Cl. H04N 7/18

(52) U.S. Cl. 348/135; 348/E07.085

(57) ABSTRACT

A method and system for measuring structural vibration using curve fitting from a video signal, which can reduce an error in vibration measurement displacement, is provided. A method for measuring structural vibration using curve fitting from a video signal, the method includes the steps of: obtaining a video signal of the object; converting the video signal of the object into a gray video signal; adjusting the brightness of the converted video signal; separating an area to be measured from the brightness-adjusted video signal; selecting an edge area of the object from a video signal of the separated area; removing noises from the edge regions; and performing curve fitting with respect to the noise-removed video signal of the edge area. Accordingly, a displacement error is reduced, so that vibration can be more exactly measured.

### CROSS-REFERENCE TO RELATED APPLICATION

This application claims the benefit of Korean Patent Application No. 10-2009-0082554, filed on Sep. 2, 2009, in the Korean Intellectual Property Office, the disclosure of which is incorporated herein by reference.

### BACKGROUND OF THE INVENTION

1. Field of the Invention

The present invention relates to a method and system for measuring structural vibration using a video signal. More particularly, the present invention relates to a method and system in which a converted video signal of an edge area of an object is obtained by removing noises from a video signal of the object and performing curve fitting, so that a displacement error can be reduced.

2. Description of Related Art

Accelerometers, laser vibrometers or the like are frequently used to measure vibrations of a structure such as buildings, bridges, tunnels and pipes. That is, a device such as an accelerometer, laser vibrometer or displacement sensor is installed in a structure and vibration of the structure is then measured through the installed device, thereby detecting whether or not there exists a defect in the structure.

However, unlike a general structure, there is a concern about the leakage of radioactivity in a high-temperature and radioactive zone such as a thermal power plant or nuclear power plant. Hence, it is difficult that a device such as an accelerometer, laser vibrometer or displacement sensor is installed in a structure and vibration of the structure is then measured through the installed device.

Therefore, a method is required in which, for a structure installed in a high-temperature and radioactive zone, vibration of the structure is measured from a long distance without attaching a sensor to the structure, thereby detecting whether or not there exists a defect in the structure.

Recently, there has been proposed a method of measuring structural vibration not by using an existing sensor but by using a video signal of a camera. By using the camera, vibrations at many points can be simultaneously measured with one shot. However, the camera has a resolution problem and is very sensitive to measurement environment.

### BRIEF SUMMARY

Disclosed herein is a method and system for measuring structural vibration using a video signal, in which vibration of a structure is measured from a long distance without attaching a sensor or the like directly to the structure, thereby detecting whether or not there exists a defect in the structure.

Disclosed herein is a method and system for measuring structural vibration using a video signal, in which.

According to an aspect of the present invention, there is provided a system for measuring structural vibration using a video signal, the system including: a video signal obtaining unit configured to obtain a video signal of an object of which vibration is to be measured; a converted video signal obtaining unit configured to select an area to be measured from the obtained video signal and to convert the video signal of the selected area; a coordinate determining unit configured to determine coordinates in the selected area of the object based on the converted video signal; and a vibration measuring unit configured to measure vibration using a displacement in the selected area of the object, wherein the converted video signal obtaining unit obtains a video signal of an edge area by removing noises of the video signal in the edge area of the object and performing curve fitting.

The video signal obtaining unit may be a camera.

The converted video signal obtaining unit may include: a pre-processing module configured to convert the video signal into a gray video signal and to perform brightness adjustment; a selected area separating module configured to separate an area to be measured from the brightness-adjusted video signal; an edge detecting module configured to select an edge area of the object from a video signal of the separated area; a noise removing module configured to remove noises except the edge area; and a curve fitting module configured to perform curve fitting with respect to the noise-removed video signal of the edge area.

The vibration measuring unit may measure the vibration of the object based on a displacement for each time in the coordinates in the edge area.

According to an aspect of the present invention, there is provided a method for measuring structural vibration using a video signal, the method including the steps of: obtaining a video signal of an object; converting a video signal of a selected area from the video signal of the object; obtaining coordinates in the selected area from the converted video signal; and measuring vibration based on a displacement in the selected area of the object, wherein the step of obtaining the converted video signal obtains a converted video signal of an edge area by removing noises of the video signal in the edge area of the object and performing curve fitting.

The video signal of the object may be obtained using a camera.

The step of obtaining the converted video signal may include the steps of: converting an original video signal of the object into a gray video signal; adjusting the brightness of the converted video signal; separating an area to be measured from the brightness-adjusted video signal; selecting an edge area of the object from a video signal of the separated area; removing noises from the edge regions; and performing curve fitting with respect to the noise-removed video signal of the edge area.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a configuration view of a system for measuring structural vibration using a video signal according to an embodiment of the present invention;

FIGS. 2a and 2b illustrate a selected and separated video signal of an edge portion and a noise-removed video signal, respectively;

FIG. 3 illustrates a video signal of an edge portion linearized through curve fitting;

FIGS. 4a and 4b are graphs respectively illustrating a displacement measurement result obtained by simply performing video signal processing and a displacement measurement result obtained by a method according to an embodiment of the present invention; and

FIGS. 5a and 5b are graphs respectively illustrating results obtained by measuring structural vibration of a real pipe structure for each time.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

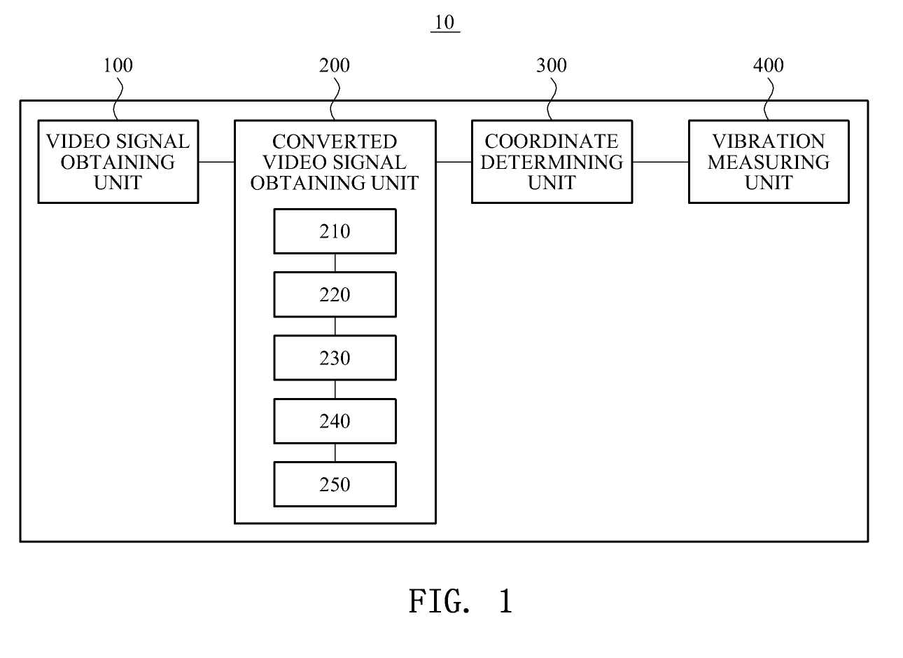

FIG. 1 is a configuration view of a system 10 for measuring structural vibration using a video signal according to an embodiment of the present invention.

Referring to FIG. 1, the system 10 includes a video signal obtaining unit 100, a converted video signal obtaining unit 200, a coordinate determining unit 300 and a vibration measuring unit 400.

The video signal obtaining unit 100 obtains a video signal of an object of which vibration is to be measured. The video signal obtaining unit 100 may be a camera. The camera obtains an original video signal by photographing a video signal of an area of the object, which is to be measured.

The object may be a structure such as a tube, pipe or iron bar contained in a building, bridge, tunnel or the like, and may be preferably a structure of a nuclear power plant or thermal power plant, to which a sensor or the like is not easily attached.

The converted video signal obtaining unit 200 includes a pre-processing module 210, a selected area separating module 220, an edge detecting module 230, a noise removing module 240 and a curve fitting module 250. The converted video signal obtaining unit 200 processes the original video signal photographed by the video signal obtaining unit 100 so as to measure the displacement of a desired area of the object.

The pre-processing module 210 converts the original video signal photographed by the video signal obtaining unit 100 into a gray video signal and performs brightness adjustment.

The selected area separating module 220 selects an area of which displacement is to be measured in the brightness-adjusted video signal and separates only the selected area from the brightness-adjusted video signal.

The edge detecting module 230 detects an edge area of the separated video signal of the object. When the vibration of the object is measured using the camera, an edge area of the object to be measured is necessarily obtained through video signal processing, and a degree of the vibration of the object can be measured by measuring the displacement of the edge area.

The noise removing module 240 removes an unnecessary noise video signal except the selected edge area.

The curve fitting module 250 connects discontinuous edge portions in the selected area to be a straight line by using curve fitting.

Specifically, an edge area may not be exactly detected depending on the resolution of the camera or measurement environment. That is, after the noise is removed, the video signal of the edge area is not continuously formed but has a discontinuous section. A method of performing noise removal may be considered so that the discontinuous section in the edge area is not produced. In this case, the noise is not removed to a desired degree. The discontinuous section causes a displacement error of the edge area, and therefore, the displacement error acts as a factor that the accuracy of a vibration measurement result is degraded.

The curve fitting module 250 removes the discontinuous section in the video signal of the edge area by linearizing the edge portions in the edge area separated from the selected area using the curve fitting.

The coordinate determining unit 300 projects the video signal of the edge area in the selected area onto a coordinate system and determines coordinates in a desired edge area from the coordinate system.

The vibration measuring unit 400 measures the displacement of the edge area for each time based on the coordinates in the edge area determined by the coordinate determining unit 300. The displacement of the edge area for each time is analyzed, so that vibration of the edge area selected from the object can be measured.

Hereinafter, a method for measuring structural vibration using the system 10 will be described.

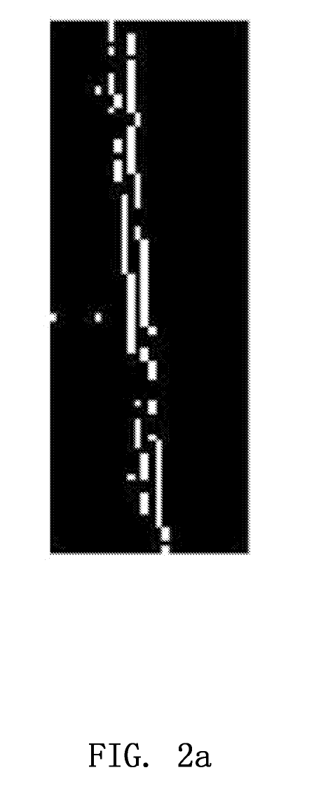

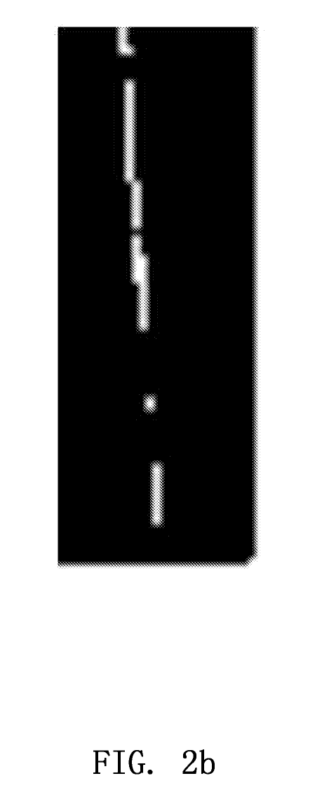

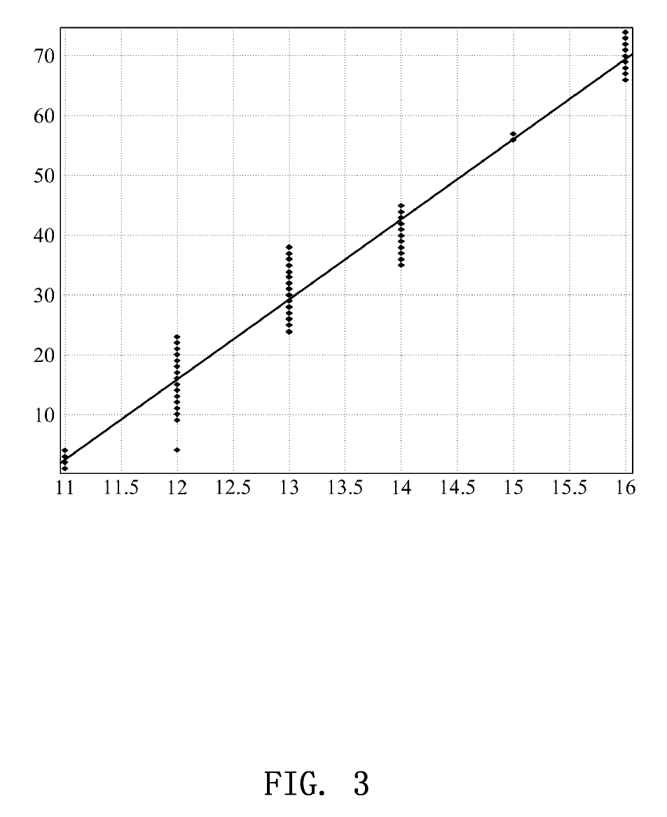

FIG. 2a illustrates a video signal of an edge area separated from a selected area, and FIG. 2b illustrates a noise-removed video signal. FIG. 3 illustrates a video signal of an edge portion linearized through curve fitting.

An object of which vibration is to be measured may be various structures such as a building, bridge, plant facility or pipe. In this embodiment, a method for measuring vibration of a pipe will be described as an example.

A video signal of the pipe that is an object may be obtained through the image obtaining unit 100. Preferably, the video signal of the pipe may be photographed using a camera.

The video signal of the pipe is subjected to video signal pre-processing through the pre-processing module 210 in the converted video signal obtaining unit 200. That is, the original video signal of the pipe is converted into a gray video signal. In this case, brightness adjustment may be performed at a desired level. Accordingly, the video signal of the pipe that is a displacement measurement object becomes clearer.

Referring to FIGS. 2a and 2b, only a selected area is separated from the brightness-adjusted video signal by the selected area separating module 220, and an edge area is detected from the separated video signal by the edge detecting module 230. Then, noises except the edge area are removed by the noise removing module 240.

Specifically, a desired area is selected from the brightness-adjusted video signal, and the selected area is separated. As illustrated in FIG. 2a, a large number of noises except edge portions exist in the image of the edge area. Such noises are necessarily removed because they interrupt the displacement measurement of the edge area. As illustrated in FIG. 2b, the noises except the edge portions are removed through noise removal video signal processing. However, as illustrated in FIG. 2b, the video signal of the edge area separated from the selected area has a discontinuous section by passing through the noise removal video signal processing. The discontinuous section causes an error in the displacement measurement, and therefore, the edge portions in the edge area are linearized by the curve fitting module 250.

That is, referring to FIG. 3, the edge portions in the edge area separated from the selected area are linearized using the curve fitting, so that coordinates in a desired edge area in the selected area can all be obtained.

The same method as described above is repeated in the next frame of the photographed video signal, so that the displacement of a video signal for each time can be obtained in a desired pipe area.

After the coordinates in the edge area in the selected area are obtained by the coordinate determining unit 300, the vibration in the selected area of the object is measured by analyzing the displacement of the edge area for each time through the vibration measuring unit 400. The state of the object and the presence of a defect of the object can be measured based on the vibration measurement result.

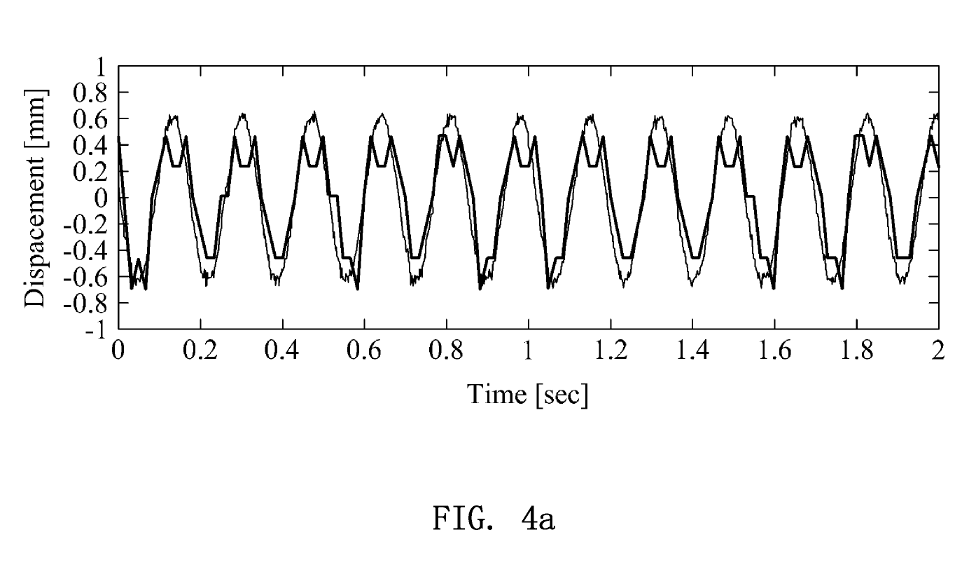

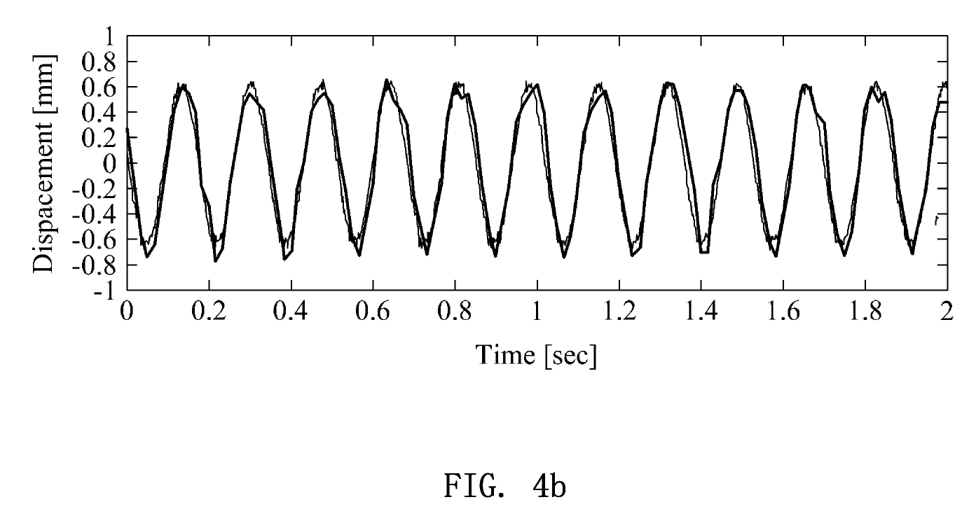

FIG. 4a is a graph illustrating a displacement for each time, measured using an accelerometer, and a displacement for each time, measured using simple video signal processing according to the related art. FIG. 4b is a graph illustrating the displacement for each time, measured using the accelerometer, and a displacement for each time, measured using a video signal processing method according to the present invention.

Referring to FIG. 4a, when compared with the displacement measurement result using the accelerometer, the related art displacement measurement result using the simple video signal processing does not reflect an exact displacement of the object for each time. This is because there exists a discontinuous section of the edge area, produced in the noise removal after the video signal processing.

In comparison therewith, the result obtained by measuring the displacement for each time using the video signal processing method including the curve fitting according to the present invention will be described with reference to FIG. 4b. It can be seen that the displacement measurement result using the video signal processing method according to the present invention is hardly different from the displacement measurement result using the accelerometer. That is, the vibration measuring method using a video signal according to the present invention can almost exactly reflect the vibration in the selected area of the object to be measured.

In other words, the experimental results of FIGS. 4a and 4b show that the vibration measuring method including the curve fitting according to the present invention has superior accuracy to the related art video signal processing method including no curve fitting.

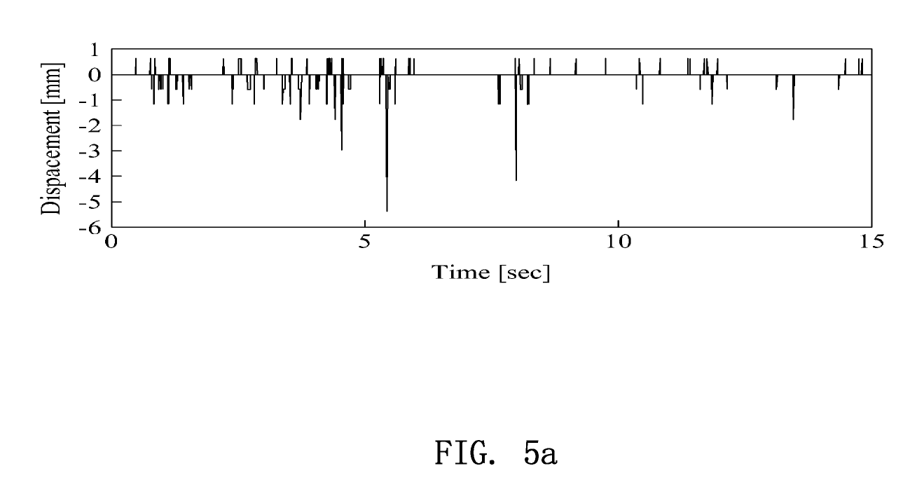

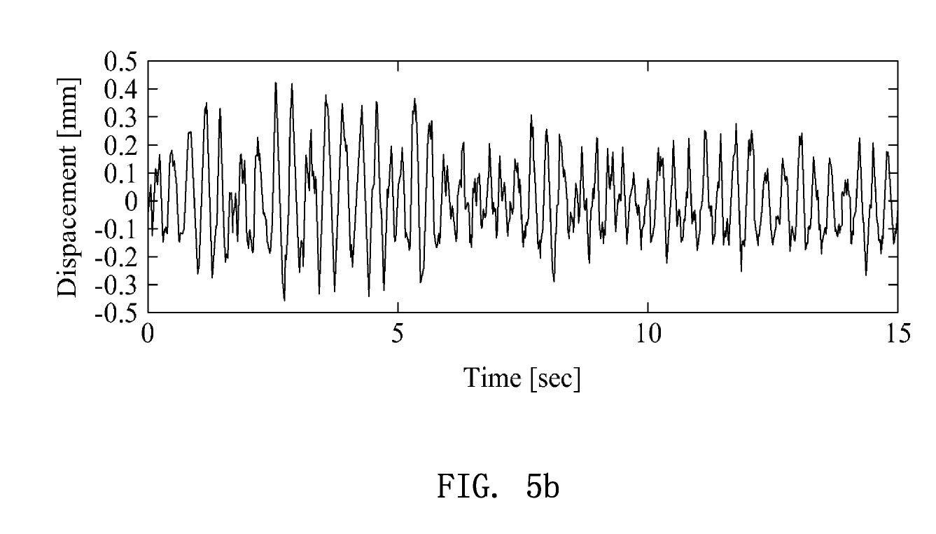

FIGS. 5a and 5b are graphs respectively illustrating results obtained by measuring structural vibration of a real pipe structure for each time. FIG. 5a illustrates a vibration measurement result using the related art video signal processing method including no curve fitting. FIG. 5b illustrates a vibration measurement result using the video signal processing method including the curve fitting according to the present invention.

Referring to FIG. 5a, the vibration measurement result using the related art video signal processing method including no curve fitting does not reflect an exact vibration for each time in the pipe structure due to the discontinuous section that exists in an edge area.

On the other hand, referring to FIG. 5b, in the vibration measuring method using a video signal according to the present invention, the discontinuous section in an edge area is removed through the curve fitting of the pipe structure, so that the vibration of the real pipe structure can be relatively exactly measured.

When vibration of a structure is measured, the method and system for measuring structural vibration using a video signal according to the present invention can reduce a displacement error as compared with the vibration measurement result using the related art video signal processing method. Accordingly, the accuracy of vibration measurement can be considerably improved.

In a method and system for measuring structural vibration using a video signal according to an embodiment of the present invention, vibration of an object is measured from a long distance, thereby detecting whether or not there exists a defect in the object.

In a method and system for measuring structural vibration using a video signal according to an embodiment of the present invention, a displacement error in a video signal of an object is reduced using curve fitting, thereby improving the accuracy of vibration measurement.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.” Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. Section 112, sixth paragraph, unless the element is expressly recited using the phrase “means for” or, in the case of a method claim, the element is recited using the phrase “step for.”

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A system for measuring structural vibration using curve fitting from a video signal, the system comprising:
a video signal obtaining unit configured to obtain a video signal of an object of which vibration is to be measured;
a converted video signal obtaining unit configured to select an area to be measured from the obtained video signal and to convert the video signal of the selected area;
a coordinate determining unit configured to determine coordinates in the selected area of the object based on the converted video signal; and
a vibration measuring unit configured to measure vibration using a displacement in the selected area of the object,
wherein the converted video signal obtaining unit obtains a video signal of an edge area by removing noises of the video signal in the edge area of the object and performing curve fitting.

2. The system of claim 1, wherein the video signal obtaining unit comprises a camera.

3. The system of claim 1, wherein the converted video signal obtaining unit comprises:
a pre-processing module configured to convert the video signal into a gray video signal and to perform brightness adjustment;
a selected area separating module configured to separate an area to be measured from the brightness-adjusted video signal;
an edge detecting module configured to select an edge area of the object from a video signal of the separated area;
a noise removing module configured to remove noises except the edge area; and
a curve fitting module configured to perform curve fitting with respect to the noise-removed video signal of the edge area.

4. The system of claim 1, wherein the vibration measuring unit measures the vibration of the object based on a displacement for each time in the coordinates in the edge area.

5. A method for measuring structural vibration using curve fitting from a video signal, the method comprising the steps of:
obtaining a video signal of an object;
converting a video signal of a selected area from the video signal of the object;
obtaining coordinates in the selected area from the converted video signal; and
measuring vibration based on a displacement in the selected area of the object,
wherein the step of obtaining the converted video signal obtains a converted video signal of an edge area by removing noises of the video signal in the edge area of the object and performing curve fitting.

6. The method of claim 5, wherein the video signal of the object is obtained using a camera.

7. The method of claim 6, wherein the step of obtaining the converted video signal comprises the steps of:
converting an original video signal of the object into a gray video signal;
adjusting the brightness of the converted video signal;
separating an area to be measured from the brightness-adjusted video signal;
selecting an edge area of the object from a video signal of the separated area;
removing noises from the edge regions; and
performing curve fitting with respect to the noise-removed video signal of the edge area.
